(19) United States
(12) Patent Application Publication
(10) Pub. No.: US 2026/0349880 A1
(43) Pub. Date: Nov. 5, 2026

(54) ELECTRONIC APPARATUS AND CONTROL METHOD

(71) Applicant: Lenovo Japan LLC, Tokyo (JP)

(72) Inventors: Yusaku Morishige, Kanagawa (JP); Ken Sasaki, Kanagawa (JP); Naoyuki Araki, Kanagawa (JP); Kazuo Shiba, Kanagawa (JP)

(73) Assignee: Lenovo Japan LLC, Tokyo (JP)

(21) Appl. No.: 19/456,180

(22) Filed: Jan. 22, 2026

(30) Foreign Application Priority Data
Mar. 6, 2025 (JP) 2025-035640

(51) Int. Cl. G06F 11/14

(52) U.S. Cl. CPC G06F 11/1438

(57) ABSTRACT

An electronic apparatus includes: a device configured to perform an operation in accordance with firmware; and an interface configured to provide a communication function. The operation has an option of being able to select whether or not to perform the operation. The device is configured to: enable the communication function intermittently; and when the communication function is enabled, execute processing of the option in accordance with a command received from an external apparatus.

### CROSS-REFERENCE TO RELATED APPLICATIONS

This application claims priority to Japanese Patent Application No. 2025-035640 filed on Mar. 6, 2025, the contents of which are hereby incorporated herein by reference in their entirety.

### TECHNICAL FIELD

The present application relates to an electronic apparatus and a control method, for example firmware maintenance.

### BACKGROUND

Personal computers (PCs) and other electronic apparatuses include various types of devices such as a host system. In the maintenance of electronic apparatuses, tasks such as firmware updating and operational parameter settings may be performed.

For instance, Japanese Unexamined Patent Application Publication No. 2024-138038 describes an electronic apparatus configured to acquire software programs via a network for updating. The electronic apparatus is then configured to display, on a display unit, at least a software program to be enabled of the acquired software programs, download the software program to update the installed software program, enable the function of the updated software program, and enable the function of the software program after updating the software displayed as the target to be enabled. The software program that is acquired for updating via a network is firmware.

Maintenance of electronic apparatuses may be performed by executing processing of a designated software tool in response to a request from a dedicated cloud server connected to a network. During maintenance, an administrator-specified boot option may be executed remotely. To do this, Wake-on-LAN (local area network) (WOL) or remote reset may be applied to indicate the target boot option to be executed. The target boot option may be selected by a user operation at the site where the electronic apparatus is used.

However, remote maintenance relies on administrator-initiated operations, and thus the usage conditions of a user may not be taken into consideration. In addition, PCs with Ethernet ports are relatively rare these days, and WOL may not be supported in wireless LAN (WLAN) environments. In the case of user operations at the site of use, the processing requested by the administrator may not be carried out in a timely manner. In this regard, it may be possible to give the target boot option a higher priority when setting optional functions. In this case, the target boot option is executed first regardless of the necessity, which increases the time required to start up the boot option that the user actually wants to use. Therefore, the setting of the optional function is not suitable for timely start-up of a specific boot option that is used relatively infrequently.

### SUMMARY

An electronic apparatus according to the first aspect of the present application includes: a device configured to perform an operation in accordance with firmware; and an interface configured to provide a communication function, wherein the operation has an option of being able to select whether or not to perform the operation, the device is further configured to: enable the communication function intermittently; and when the communication function is enabled, execute processing of the option in accordance with a command received from an external apparatus.

The electronic apparatus may further include a timer to measure current time, and when the current time passes a predetermined date and time, the device may enable the communication function.

In the electronic apparatus, the device may include a host device included in a host system, and the host system may be configured to, in an initialization process, check validity of the communication function.

In the electronic apparatus, the host system may be configured to, when the current time passes a predetermined date and time while the electronic apparatus is in a power-off state, start the initialization process, and after the process of the option is completed, return to the power-off state.

In the electronic apparatus, the host system may be configured to operate in a low power mode that consumes less power than a standard power mode, wherein when the current time passes a predetermined date and time, the host system suspends operation before starting the initialization process, and after the process of the option is completed, the host system executes a restart process and change the power mode to the low power mode.

In the electronic apparatus, the host system may be configured to, when detecting a startup instruction while the electronic apparatus is in a power-off state, start the initialization process, when the current time passes a predetermined date and time, enable the communication function, and after the process of the option is completed, execute a startup process.

In the electronic apparatus, the device may be configured to repeat a process in accordance with the command that is a single command unexecuted, and a restart process after completion of the process until there is no more the command that is unexecuted.

A control method according to the second aspect of the present application is for an electronic apparatus including: a host system configured to perform an operation in accordance with firmware; and an interface configured to provide a communication function, the operation having an option of being able to select whether or not to perform the operation, the control method comprising: enabling, at the device, the communication function intermittently, and when the communication function is enabled; executing, at the device, processing of the option in accordance with a command received from an external apparatus.

The above-described aspects of present invention provide an opportunity to perform a certain optional process regardless of its frequency of use.

### BRIEF DESCRIPTION OF THE DRAWINGS

FIG. 1 is a block diagram schematically illustrating one example of the configuration of a maintenance system according to one or more embodiments.

FIG. 2 is a block diagram schematically illustrating an example of the hardware configuration of an electronic apparatus according to one or more embodiments.

FIG. 3 is a block diagram schematically illustrating one example of the functional configuration of the electronic apparatus according to one or more embodiments.

FIG. 4 is a flowchart of the first example of the maintenance process according to one or more embodiments.

FIG. 5 is a flowchart of the second example of the maintenance process according to one or more embodiments.

FIG. 6 is a flowchart of the third example of the maintenance process according to one or more embodiments.

FIG. 7 illustrates an example of a network connection warning screen according to one or more embodiments.

### DETAILED DESCRIPTION OF THE INVENTION

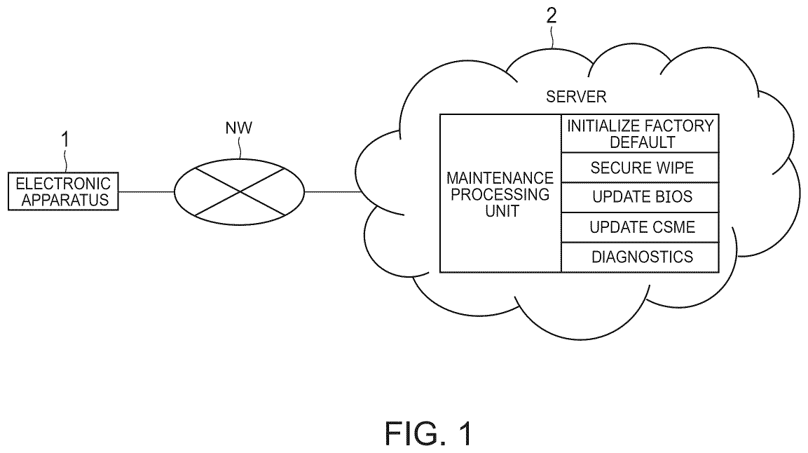

The following describes embodiments of the present application, with reference to the drawings. First, the following describes an example of the configuration of a maintenance system S1 according to one or more embodiments. FIG. 1 is a block diagram schematically illustrating one example of the configuration of the maintenance system S1 according to one or more embodiments.

The maintenance system S1 includes an electronic apparatus 1 and a server 2. The electronic apparatus 1 and the server 2 are connected by wire or wirelessly using a network NW so that various data can be transmitted and received. Part or all of the network NW is configured to include a wide area communication network such as the internet. Part of the network NW may include a narrowband communication network such as a local wireless network (LAN: Local Area Network).

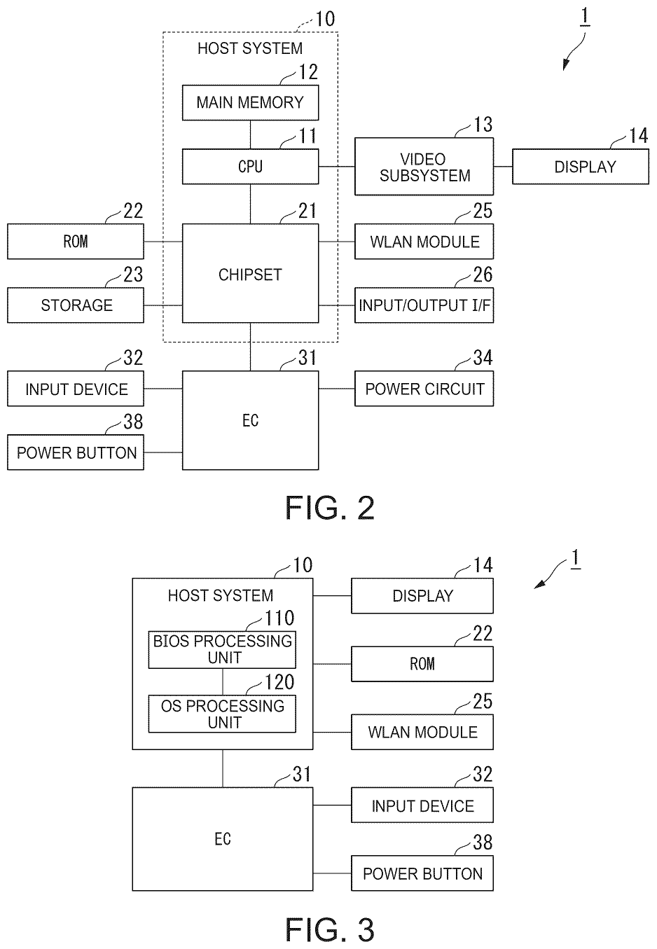

The electronic apparatus 1 includes a host system 10 (FIG. 2) that operates according to system firmware, and a communication interface for implementing communication functions with other devices. The operations based on the system firmware have options, which are functions that can be selected to be executed or not. The host system 10 intermittently enables the communication function. When the communication function is enabled, the host system 10 waits for a command sent from the server 2. When the host system 10 receives a command from the server 2, it executes optional processing in accordance with the received command.

The server 2 provides various services relating to the maintenance and management of the electronic apparatus 1.

The server 2 mainly performs maintenance of the system firmware executed in the electronic apparatus 1. System firmware refers to firmware for controlling the basic operations of the host system. In this application, the system firmware refers to a system basic input/output system (BIOS) that employs unified extensible firmware interface (UEFI), and may be simply referred to as BIOS.

The server 2 includes a maintenance processing unit that primarily performs maintenance of system firmware remotely. The maintenance processing unit is capable of providing services to the electronic apparatus 1, such as BIOS factory initialization (BIOS initialize factory default), data erasure (secure wipe), BIOS update (update BIOS), CSME update (Update converged security and management engine (CSME)), and diagnostics. CSME is firmware for managing the security of the host device. For instance, the CSME is capable of encrypting or decrypting various types of firmware and other software.

The maintenance processing unit sends a command to the electronic apparatus 1 in accordance with a predetermined communication protocol and causes the electronic apparatus 1 to execute a software tool (e.g., an EFI Tool) instructed according to the command. For instance, each command is acquired in response to an operation by an administrator. Each command may be selected according to a predetermined rule or model based on the operating state reported from the electronic apparatus 1. The system for providing this maintenance-related service is also called life cycle management (LCM). In this application, a command related to maintenance may be referred to as a “maintenance action” or simply as an “action.”

For instance, LCM hypertext transfer protocol secure (HTTPS) Boot is used as a protocol for transmitting a maintenance action. LCM HTTPS corresponds to the procedure in which UEFI BIOS HTTPS Boot (this may be simply referred to as “HTTPS Boot”) is applied to a maintenance action. A maintenance action is mainly performed during a period when the electronic apparatus 1 is not in use.

The server 2 manages maintenance execution information indicating the maintenance action acquired for the electronic apparatus 1 to be maintained and managed, and the execution status thereof. For instance, when the server 2 receives a maintenance action request from the electronic apparatus 1, the server 2 refers to the maintenance execution information and identifies an unexecuted maintenance action. The server 2 notifies the electronic apparatus 1 of the presence or absence of an unexecuted action. If there is an unexecuted maintenance action, the server 2 notifies the electronic apparatus 1 of the maintenance action. When the server 2 is notified by the electronic apparatus 1 that the execution of the notified unexecuted maintenance action has been completed, the server 2 changes the execution status of the maintenance action to executed.

The electronic apparatus 1 is a user device that is mainly used at a base where a user is located. The electronic apparatus 1 is typically used at a different location from the server 2.

The electronic apparatus 1 may be an information terminal device having any form, such as a personal computer (PC), a tablet terminal device, or a multi-function mobile phone.

The server 2 is used at the base of the manufacturer or a maintenance company, for example, of the electronic apparatus 1. The server 2 is configured as a cloud server connected to the internet.

Next, the following describes an example of the configuration of the electronic apparatus 1 according to one or more embodiments.

FIG. 2 is a block diagram schematically illustrating an example of the hardware configuration of the electronic apparatus 1 according to one or more embodiments. In the example of FIG. 2, the electronic apparatus 1 is configured as a laptop personal computer (in this application, this may be called a laptop PC).

The electronic apparatus 1 includes a host system 10, a video subsystem 13, a display 14, a read only memory (ROM) 22, a storage 23, a wireless local area network (WLAN) module 25, an input/output interface (I/F) 26, an embedded controller (EC) 31, an input device 32, a power circuit 34 and a power button 38.

The host system 10 is the core computer system of the electronic apparatus 1. The host system 10 includes a central processing unit (CPU) 11, a main memory 12, and a chipset 21. In this application, a device that makes up the host system 10 may be referred to as a “host device”.

The CPU 11 is a processor that executes various types of programs. Various programs to be executed include firmware, operating system (OS), utility software, and application programs. In this application, “executing a program” or “execution of a program” includes performing the processing directed by the commands described in the program. The CPU 11 executes various types of programs and thus works with the main memory 12 and other hardware to implement the functions of the host system 10.

The main memory 12 is a writable memory functioning as a read-in area of a program executed by the CPU 11 or a work area to write data processed by the executed program. For instance, the main memory 12 includes a plurality of dynamic random access memory (DRAM) chips. The CPU 11 and main memory 12 are the minimum hardware components that make up the host system 10.

The video subsystem 13 is a subsystem to implement the functions relating to image display. The video subsystem 13 includes a video controller and a video memory (not illustrated). The video controller generates drawing information in accordance with a drawing command input from the CPU 11, and writes the generated drawing information into the video memory. The video memory temporarily stores the drawing information generated by the video controller. The video controller reads the drawing information stored in the video memory at a predetermined cycle and outputs, to the display 14, the display data showing the display screen made up of the read-out drawing information.

The display 14 displays a display screen on the basis of the display data input from the video subsystem 13. For instance, the display 14 may be any of a liquid crystal display (LCD), an organic light emitting diode (OLED) display, and others.

The chipset 21 includes one or more controllers and is connectable to a plurality of devices for input/output of various data. For instance, the controller in the chipset 21 may be any of a universal serial bus (USB), a serial peripheral interface (SPI) bus, and a PCI-Express bus. In the example of FIG. 1, the chipset 21 is connected to the ROM 22, the storage 23, the WLAN module 25, the input/output I/F 26, and the EC 31.

The ROM 22 mainly stores firmware. The firmware stored in the ROM 22 includes system firmware such as BIOS and firmware for controlling individual devices. Firmware typically includes a plurality of driver software programs (this may be simply referred to as “drivers” in this application). In this application, BIOS refers to the system firmware that directs the operation of the host device and boots the OS, and mainly refers to the system BIOS that employs the unified extensible firmware interface (UEFI) (i.e., UEFI BIOS), which may include UEFI driver. The ROM 22 may be any of an electrically erasable programmable read only memory (EEPROM), a flash ROM, and others.

The storage 23 is an auxiliary storage device that non-temporarily stores various data used in the processing of the host system 10, various data obtained by those processes, or various programs in a readable and writable manner. For instance, the storage 23 may be any of a solid state drive (SSD) and a hard disk drive (HDD).

The WLAN module 25 connects to the WLAN so as to be able to transmit and receive various types of data. The WLAN module 25 enables the transmission and reception of various data to and from other devices connected to WLAN or other networks via WLAN. The other networks may be any one of the internet, a public wireless network, and a virtual private network.

The input/output I/F 26 connects to various devices by wire or wirelessly to enable input/output of data. For instance, the input/output I/F 26 includes a USB connector.

The USB connector is for inputting and outputting data via a wired connection in accordance with USB specifications.

The EC 31 monitors and controls the operation of various types of devices connected thereto, irrespective of the operating state of the host system 10. The EC 31 includes a CPU, a ROM, a RAM, a timer (e.g., a real time clock (RTC) timer), and an input/output I/F, which are independent of those in the host system 10. A device with a slower data transfer rate than the chipset 21 may be connected to the EC 31. In the example of FIG. 1, the input device 32, the power circuit 34, and the power button 38 are connected to the EC 31.

The input device 32 detects an operation by a user, generates an operation signal corresponding to the detected operation and outputs the generated operation signal to the EC 31. For instance, the input device 32 may be any one or a combination of a keyboard, a touch sensor and a track point. The power circuit 34 executes power supply to various devices under the control of the EC 31. The power circuit 34 includes a charger and a transformer (DC/DC, direct current/direct current).

The charger charges the battery with surplus power that is left unconsumed in each device from the power supplied by the external power source. If no power is supplied from the external power source, or if the power supplied by the external power source does not meet the demand from each device, the charger supplies each device with power discharged from the battery via the transformer.

The transformer converts the voltage of the DC power supplied from the external power source or the battery via the charger into the voltage required for the operation of each device. The transformer supplies the DC power having the converted voltage to a destination device.

Each time the power button 38 is pressed, it notifies the EC 31 of an instruction to the electronic apparatus 1 to power on or power off. When the power button 38 receives a pressing operation, it outputs a pressing signal indicating the pressing to the EC 31. When the electronic apparatus 1 is in a power-off state and a pressing signal is input from the power button 38, the EC 31 causes the power circuit 34 to start supplying power to each device of the electronic apparatus 1 (power-on).

When power is supplied to the electronic apparatus 1 and a pressing signal is input from the power button 38, the EC 31 causes the CPU 11 to execute a stop process (shutdown). In the stop process, the CPU 11 saves the data that exists in the work area at that time in the storage 23. After saving data is finished, the CPU 11 stops processing based on applications, device drivers, and other programs running at that time. Thereafter, the CPU 11 notifies the EC 31 of the completion of the stop process. The EC 31 causes the power circuit 34 to stop supplying power to each device of the electronic apparatus 1.

Next, the following describes an example of the functional configuration of the electronic apparatus 1 according to one or more embodiments. FIG. 3 is a block diagram schematically illustrating one example of the functional configuration of the electronic apparatus 1 according to one or more embodiments.

The host system 10 includes a BIOS processing unit 110 and an OS processing unit 120.

The functions of the BIOS processing unit 110 are implemented by the CPU 11 executing the BIOS.

When the CPU 11 detects power-on, it reads out various drivers that make up the BIOS stored in advance in the ROM 22 and starts the function of the BIOS processing unit 110. At this time, the BIOS processing unit 110 executes the preboot process. The preboot process is part of the startup process. The preboot process includes detecting devices that make up the electronic apparatus 1, initializing the detected devices (POST process), and loading the OS. In the present application, the startup process refers to a series of processes from power-on to making the entire electronic apparatus 1 available so that it can perform its expected functions. Boot mainly refers to the process of starting the OS (OS boot). Reboot mainly refers to the process of restarting.

The BIOS processing unit 110 manages the detected devices and supports the control of the devices by the OS and input/output even after the OS has started up.

The BIOS processing unit 110 is preset with maintenance boot enabled, LCM HTTPS Boot as the maintenance boot option, a maintenance cycle (e.g., week or day), and a maintenance time within that cycle (e.g., a combination of day of the week and time, or time). These settings may be specified as setting items in the BIOS setup. When setting the maintenance cycle and maintenance time, RTC (Real-time Clock) Wake settings are applied, for example. RTC Wake settings are setting information for the RTC timer. The RTC timer measures the time at the time (current time). The RTC timer operates whether or not power is supplied to the host system 10.

The BIOS processing unit 110 activates the function of communicating with the server 2 at the set startup time for each set cycle, and acquires any unexecuted action issued by the server 2. To acquire the action, the BIOS processing unit 110 attempts LCM HTTPS boot to activate the communication function. LCM HTTPS boot corresponds to one of the boot options related to BIOS maintenance. When attempting LCM HTTPS Boot, the BIOS processing unit 110 installs a driver related to LCM HTTPS Boot. That is, the BIOS processing unit 110 reads that driver from the ROM 22, loads the read driver into the main memory 12, and makes it executable. The BIOS processing unit 110 accesses the server 2 using the WLAN module 25 and acquires any unexecuted action at that time. The BIOS processing unit 110 executes the processing instructed by the acquired action. Thereafter, the BIOS processing unit 110 starts (boots) the OS if it has not been started, and restarts (reboots) the OS if it is currently running.

The OS processing unit 120 executes the OS and related software to provide basic functions. Related software refers to software that works with the OS. The related software includes device drivers and utilities. The basic functions include memory management, task management, file management, input/output management, and execution management of application software (this may be referred to as “apps” or “applications” in this application). The functions of the OS processing unit 120 are provided after boot or reboot of the OS has been completed. The OS processing unit 120 may notify the EC 31 of the power mode of the host system 10 when the power mode is changed. The EC 31 transmits power corresponding to the notified power mode to the host device and other devices.

In one or more embodiments, the trigger for attempting HTTPS Boot and attempting to obtain a maintenance action may be any of the following: (1) when the electronic apparatus 1 is in a state of power off; (2) when the power mode is in sleep mode (e.g., modern standby) while the OS is running; and (3) during startup processing in response to a user operation (e.g., pressing the power button 38).

The BIOS processing unit 110 is notified of the current time from the RTC timer, and when the current time reaches the maintenance time at each maintenance cycle, the BIOS processing unit 110 attempts HTTPS Boot.

If the electronic apparatus 1 is in a state of power off at the maintenance time, the EC 31 causes the power circuit 34 to power on the host device. The BIOS processing unit 110 starts its function and attempts HTTPS Boot.

However, after the execution of the maintenance action and the completion of the OS boot or reboot, the CPU 11 executes a stop process. This causes the electronic apparatus 1 to return to a power-off state.

If the OS is running at the maintenance time and the power mode is sleep mode, the OS processing unit 120 stops processing on the OS at that time and places it in a hibernation state. Specifically, the OS processing unit 120 saves, in the storage 23, the image data including the program being processed, which indicates the processing state at that time, the data, and the parameters used in the processing. Thereafter, the CPU 11 stops its processing, and the EC 31 causes the power circuit 34 to temporarily stop supplying power to the host device. The EC 31 then causes the power circuit 34 to resume power supply to the host device. The BIOS processing unit 110 resumes its function and attempts HTTPS Boot. However, after the execution of the action and the completion of the boot or reboot of the OS, the OS processing unit 120 transitions the power mode from the normal mode to the sleep mode.

If startup processing is being performed in response to a user operation at the maintenance time, the BIOS processing unit 110 starts its function and attempts HTTPS Boot. However, after the execution of the action and the completion of the boot or reboot of the OS, the OS processing unit 120 maintains its power mode that is the normal mode.

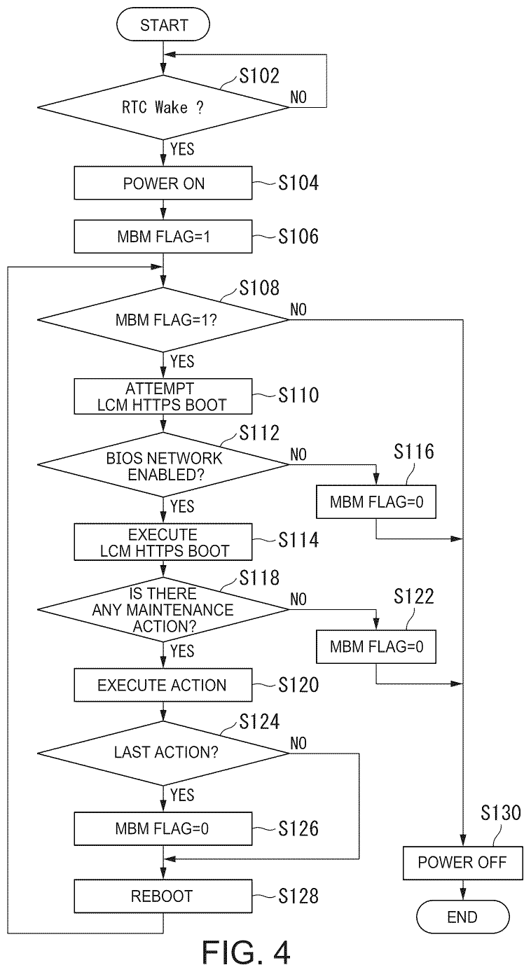

Next, the following describes a first example of the maintenance process according to one or more embodiments. FIG. 4 is a flowchart of the first example of the maintenance process according to one or more embodiments. The process in FIG. 4 is an exemplary case where the process is started when the state of the electronic apparatus 1 is power off.
(Step S102) The RTC timer determines whether the current time has passed the maintenance time set in the RTC Wake settings. If it is determined that it has passed (YES in step S102), the process proceeds to step S104. If it is determined that it has not passed (NO in step S102), the process repeats step S102.
(Step S104) The EC 31 causes the power circuit 34 to power on the host device. At this time, the functioning of the BIOS processing unit 110 starts.
(Step S106) The BIOS processing unit 110 sets the initial value of a maintenance boot mode (MBM) flag to 1. The MBM flag is one-bit information that indicates whether the apparatus operates in a maintenance boot mode, depending on whether its value is 1 or 0.
(Step S108) If the value of the MBM flag is 1 (YES in step S108), the process proceeds to step S110. If the value of the MBM flag is 0 (NO in step S108), the process proceeds to step S130.
(Step S110) The BIOS processing unit 110 attempts LCM HTTPS Boot.
(Step S112) The BIOS processing unit 110 determines whether the BIOS Network is enabled. BIOS Network being enabled indicates that the communication function is enabled. That is, the communication interface (in the example of FIG. 1, the WLAN module 25) is detected, and the driver required to implement the communication function is executable. If it is enabled (YES in step S112), the process proceeds to step S114. If it is not enabled (NO in step S112), the process proceeds to step S116.
(Step S114) The BIOS processing unit 110 executes LCM HTTPS Boot, accesses the server 2, and transmits a maintenance action request for the electronic apparatus 1.
(Step S116) The BIOS processing unit 110 sets the value of the MBM flag to 0. Then, the process proceeds to step S130.
(Step S118) In response to the maintenance action request, the BIOS processing unit 110 is notified by the server 2 whether or not there is an unexecuted maintenance action. If there is an unexecuted maintenance action (YES in step S118), the process proceeds to step S120. In this case, the BIOS processor 110 is notified of the unexecuted maintenance action. If there is no unexecuted maintenance action (NO in step S118), the process proceeds to step S122.
(Step S120) The BIOS processing unit 110 executes the unexecuted maintenance action. If multiple unexecuted maintenance actions are notified, the BIOS processing unit 110 executes the first maintenance action in the sequence and does not execute the other unexecuted maintenance action(s). When the BIOS processing unit 110 has completed the execution of the maintenance action, it notifies the server 2 of the completion of the execution of the maintenance action.
(Step S122) The BIOS processing unit 110 sets the value of the MBM flag to 0. Then, the process proceeds to step S130.
(Step S124) The BIOS processing unit 110 determines whether the maintenance action whose execution has been completed is the last maintenance action of the notified unexecuted maintenance actions. If it is determined that this is the last maintenance action (YES in step S124), the process proceeds to step S126. If it is not determined that this is the last maintenance action (NO in step S124), the process proceeds to step S128.
(Step S126) The BIOS processing unit 110 sets the value of the MBM flag to 0.
(Step S128) The BIOS processing unit 110 executes the POST process, and then starts the reboot process of the OS. If there is only one unexecuted maintenance action notified, or if it is after the execution of the first maintenance action among multiple unexecuted maintenance actions, the BIOS processing unit 110 starts a normal boot process instead of a reboot process. Then, the process proceeds to step S108.
(Step S130) The CPU 11 executes a stop process. Thereafter, the EC 31 causes the power circuit 34 to stop supplying power to each device of the electronic apparatus 1 (power off). After that, the process of the FIG. 4 ends.

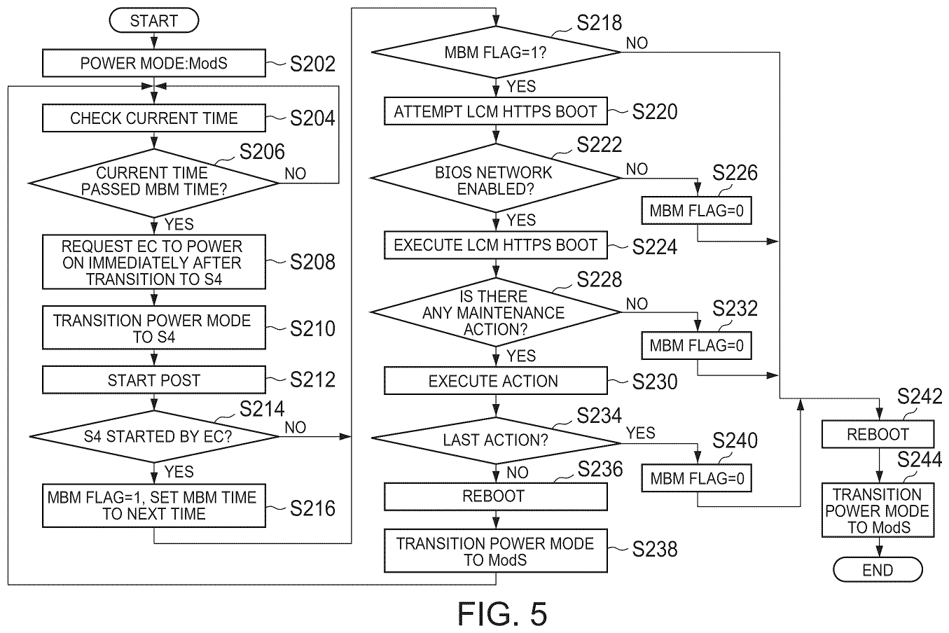

Next, the following describes a second example of the maintenance process according to one or more embodiments. FIG. 5 is a flowchart of the second example of the maintenance process according to one or more embodiments. The process in FIG. 5 is an exemplary case where the process is started with the OS of the electronic apparatus 1 already started and running.
(Step S202) When the power mode of the host system 10 is normal mode, the OS processing unit 120 detects the usage state of the electronic apparatus 1, and if a predetermined transition condition is met, the OS processing unit 120 transitions the power mode from normal mode to modern standby (ModS). The transition condition is an event that infers non-use or indifference by the user. The transition condition includes, for example, when no user operation is detected continuously for a predetermined time or longer, and when a sleep command is issued in response to a user operation according to a setting screen. For laptop PCs, the transition condition includes the case where two connected chassis are closed. For instance, a laptop PC has a sensor in one of its chassis, and is capable of detecting whether the other chassis is open or closed based on a physical quantity (e.g., a magnetic field, capacitance) detected by the sensor.

The normal mode is an operation mode in which the electronic apparatus 1 performs the expected functions. The normal mode corresponds to the SO state among the power states defined by the advanced configuration and power interface (ACPI). Modern standby is an operation mode that consumes less power than the normal mode, and involves a state in which the presentation of information to the user, such as a screen display, stops (screen off). However, in modern standby, connections with other devices and acceptance of operational inputs are maintained. Modern standby is a type of sleep state, but corresponds to an extended SO state.
(Step S204) The OS processing unit 120 checks the current time notified by the RTC timer.
(Step S206) The OS processing unit 120 determines whether the current time has passed the MBM time. The above-described maintenance time is set as the initial value of the MBM time. If it is determined that the current time has passed the MBM time (YES in step S206), the process proceeds to step S208. If it is determined that the current time has not passed the MBM time (NO in step S206), the process returns to step S204.
(Step S208) The OS processing unit 120 notifies the BIOS processing unit 110 and the EC 31 of a power-on request to the host device immediately after the power mode of the host system 10 has transitioned to the S4 state. The S4 state corresponds to a hibernation state in which the operation of the host device is stopped, among the power states defined by ACPI. Immediately before changing the power mode to the S4 state, the CPU 11 saves the operating state of the electronic apparatus 1 up to that point. At this time, the CPU 11 stores, in the storage 23, image data indicating various information developed in the main memory 12, and then causes the power circuit 34 to stop supplying power to itself and the main memory 12 using the EC 31. The BIOS processing unit 110 sets the S4 startup by the EC 31 in response to a power-on request notified by the OS processing unit 120. The S4 startup refers to resuming the functions of the host system 10 and transitioning the power mode from the S4 state to the normal mode.
(Step S210) In response to the notified power-on request, the EC 31 causes the power circuit 34 to resume power supply to the host device.
(Step S212) When power is supplied to the host device, the BIOS processing unit 110 resumes functioning and the POST process starts.
(Step S214) The BIOS processing unit 110 determines whether S4 startup (S4 Wake) is set by the EC 31. If S4 startup is set (YES in step S214), the process proceeds to step S216. If S4 startup is not set (NO in step S214), the process proceeds to step S218. If S4 startup is not set, the electronic apparatus 1 may be started by pressing the power button 38, for example.
(Step S216) The BIOS processing unit 110 sets the value of the MBM flag to 1, and sets the MBM time to the next time. The next time corresponds to the time after the elapse of a predetermined processing cycle from the current time.

For the processing cycle, the upper limit of the time required for one cycle of the processing, including the transition of the power mode from modern standby to S4 state, S4 startup, action execution, reboot, and transition of the power mode from so state to modern standby, may be set in advance in the BIOS processing unit 110.
(Step S218) The BIOS processing unit 110 identifies the value of the MBM flag. If the value of the MBM flag is 1 (YES in step S218), the process proceeds to step S220. If the value of the MBM flag is not 1 (NO in step S218), the process proceeds to step S242.
(Step S220) The BIOS processing unit 110 attempts LCM HTTPS Boot.
(Step S222) The BIOS processing unit 110 determines whether the BIOS Network is enabled. If it is enabled (YES in step S222), the process proceeds to step S224. If it is not enabled (NO in step S222), the process proceeds to step S226.
(Step S224) The BIOS processing unit 110 executes LCM HTTPS Boot, accesses the server 2, and transmits a maintenance action request for the electronic apparatus 1.
(Step S226) The BIOS processing unit 110 sets the value of the MBM flag to 0. Then, the process proceeds to step S242.
(Step S228) In response to the maintenance action request, the BIOS processing unit 110 is notified by the server 2 whether or not there is an unexecuted maintenance action. If there is an unexecuted maintenance action (YES in step S228), the process proceeds to step S230. If there is no unexecuted maintenance action (NO in step S228), the process proceeds to step S232.
(Step S230) The BIOS processing unit 110 executes the unexecuted maintenance action. If multiple unexecuted maintenance actions are notified, the BIOS processing unit 110 executes the first maintenance action in the sequence and does not execute the other unexecuted maintenance action(s). When the BIOS processing unit 110 has completed the execution of the maintenance action, it notifies the server 2 of the completion of the execution of the maintenance action.
(Step S232) The BIOS processing unit 110 sets the value of the MBM flag to 0. Then, the process proceeds to step S242.
(Step S234) The BIOS processing unit 110 determines whether the maintenance action whose execution has been completed is the last maintenance action of the notified unexecuted maintenance actions. If it is determined that this is the last maintenance action (YES in step S234), the process proceeds to step S240. If it is not determined that this is the last maintenance action (NO in step S234), the process proceeds to step S236.
(Step S236) The BIOS processing unit 110 causes the OS to reboot. After that, the OS processing unit 120 starts functioning.
(Step S238) The OS processing unit 120 transitions the power mode from the normal mode to the modern standby (ModS). Then, the process returns to step S204.
(Step S240) The BIOS processing unit 110 sets the value of the MBM flag to 0.
(Step S242) The BIOS processing unit 110 causes the OS to reboot. After that, the OS processing unit 120 starts functioning.
(Step S244) The OS processing unit 120 transitions the power mode from the normal mode to the modern standby. After that, the process of the FIG. 5 ends.

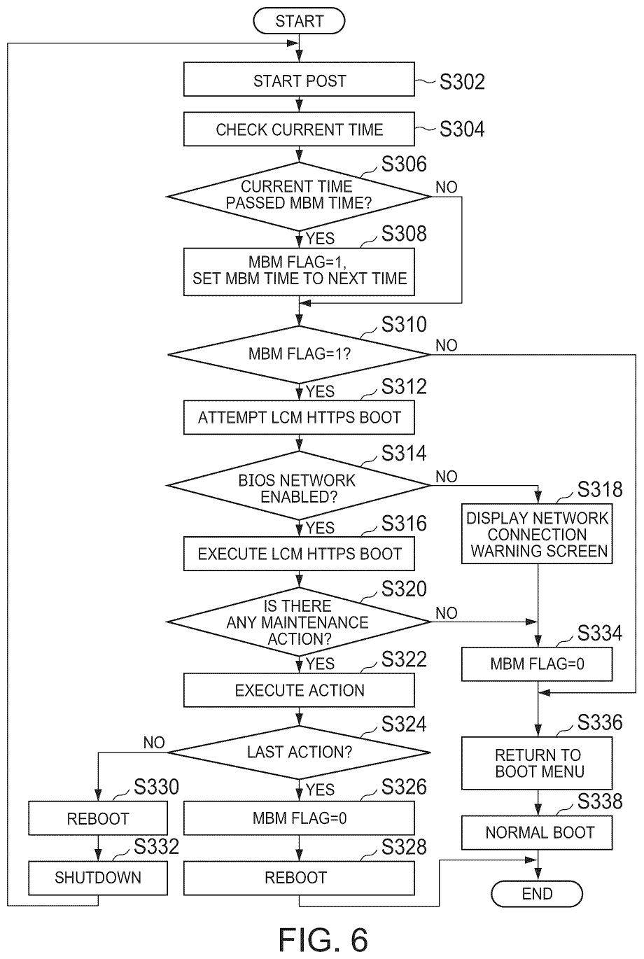

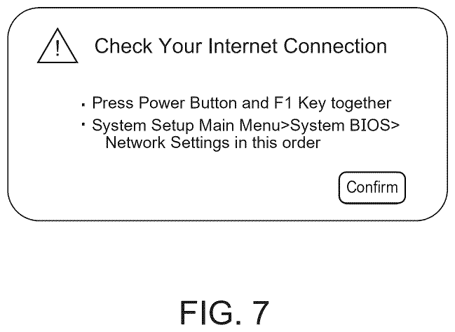

Next, the following describes a third example of the maintenance process according to one or more embodiments. FIG. 6 is a flowchart of the third example of the maintenance process according to one or more embodiments. The process in FIG. 6 is an exemplary case where when the state of the electronic apparatus 1 is power off, power supply is started in response to pressing of the power button 38.
(Step S302) When detecting that the power button 38 is pressed, the EC 31 causes the power circuit 34 to power on the host device. At this time, the functioning of the BIOS processing unit 110 starts, and a POST process starts.
(Step S304) The BIOS processing unit 110 checks the current time notified by the RTC timer.
(Step S306) The BIOS processing unit 110 determines whether the current time has passed the MBM time. The above-described maintenance time is set as the initial value of the MBM time. If it is determined that the current time has passed the MBM time (YES in step S306), the process proceeds to step S308. If it is determined that the current time has not passed the MBM time (NO in step S306), the process proceeds to step S310.
(Step S308) The BIOS processing unit 110 sets the value of the MBM flag to 1, and sets the MBM time to the next time. The next time corresponds to the time after the elapse of a predetermined processing cycle from the current time.
(Step S310) The BIOS processing unit 110 identifies the value of the MBM flag. If the value of the MBM flag is 1 (YES in step S310), the process proceeds to step S312. If the value of the MBM flag is not 1 (NO in step S310), the process proceeds to step S336.
(Step S312) The BIOS processing unit 110 attempts LCM HTTPS Boot.
(Step S314) The BIOS processing unit 110 determines whether the BIOS Network is enabled. If it is enabled (YES in step S314), the process proceeds to step S316. If it is not enabled (NO in step S314), the process proceeds to step S318.
(Step S316) The BIOS processing unit 110 executes LCM HTTPS Boot, accesses the server 2, and transmits a maintenance action request for the electronic apparatus 1.
(Step S318) The BIOS processing unit 110 causes the display 14 to display a network connection warning screen. The network connection warning screen contains either or both of notification information indicating that a network connection cannot be established and guidance information showing how to set up a network connection (see FIG. 7). Then, the process proceeds to step S334.
(Step S320) In response to the maintenance action request, the BIOS processing unit 110 is notified by the server 2 whether or not there is an unexecuted maintenance action. If there is an unexecuted maintenance action (YES in step S320), the process proceeds to step S322. If there is no unexecuted maintenance action (NO in step S320), the process proceeds to step S334.
(Step S322) The BIOS processing unit 110 executes the unexecuted maintenance action. If multiple unexecuted maintenance actions are notified, the BIOS processing unit 110 executes the first maintenance action in the sequence and does not execute the other unexecuted maintenance action(s). When the BIOS processing unit 110 has completed the execution of the maintenance action, it notifies the server 2 of the completion of the execution of the maintenance action.
(Step S324) The BIOS processing unit 110 determines whether the maintenance action whose execution has been completed is the last maintenance action of the notified unexecuted maintenance actions. If it is determined that this is the last maintenance action (YES in step S324), the process proceeds to step S326. If it is not determined that this is the last maintenance action (NO in step S324), the process proceeds to step S330.
(Step S326) The BIOS processing unit 110 sets the value of the MBM flag to 0. Then, the process proceeds to step S328.
(Step S328) The BIOS processing unit 110 causes the OS to reboot. After that, the OS processing unit 120 starts functioning, and the process of FIG. 6 ends.
(Step S330) The BIOS processing unit 110 causes the OS to reboot. After that, the OS processing unit 120 starts functioning.
(Step S332) The OS processing unit 120 instructs the EC 31 to power on after shutdown. Then, the CPU 11 executes a stop process (shutdown). Then, the process returns to step S302. In step S302, the EC 31 causes the power circuit 34 to start supplying power to the host device, and the POST process starts.
(Step S334) The BIOS processing unit 110 sets the value of the MBM flag to 0 and exits the maintenance boot mode.
(Step S336) The BIOS processing unit 110 returns to the normal boot menu.
(Step S338) The BIOS processing unit 110 executes the normal boot process of the OS. After that, the OS processing unit 120 starts functioning, and the process of FIG. 6 ends.

The above mainly describes the case where the firmware is system firmware related to the host system, but the present invention is not limited to this case. The firmware may also be a device driver for another type of device. Other types of devices include the video subsystem 13, the display 14, the WLAN module 25, and the input/output I/F 26.

The electronic apparatus 1 is not limited to a laptop PC, but may also be a desktop PC, a tablet terminal device, or an electronic apparatus in another form. The server 2 is not necessarily limited to a server dedicated to maintenance, but may be any external apparatus that is able to provide various maintenance actions to the electronic apparatus 1 via a communication network. Such an external apparatus may be, for example, a general-purpose server such as a web server, or may be a communication device installed in the facility where the user is located, or another device installed alongside the communication device. The interface that provides the communication function is not limited to the WLAN module 25, but may be a communication interface that supports a communication method other than WLAN, such as a mobile communication card or an Ethernet card.

The above describes an example in which the electronic apparatus 1 enables the communication function at a predetermined regular maintenance cycle and every time the maintenance time elapses, and accepts a command from an external apparatus. The maintenance cycle does not necessarily have to be regular as long as the communication function is enabled intermittently. For instance, if the OS processing unit 120 is in operation at the time when the maintenance time has elapsed, the electronic apparatus 1 may execute the processes from step S104 onward in FIG. 4 after the shutdown process that is executed immediately thereafter has ended. Furthermore, the BIOS processing unit 110 may be configured to be able to set the maintenance time for each day of the week, weekday, or holiday. The BIOS processing unit 110 may record the power-on time and end time for each day, and set the maintenance time within the non-use period from the end time to the next power-on time.

As described above, the electronic apparatus 1 according to one or more embodiments includes a device that operates based on firmware and an interface that provides a communication function (e.g., the WLAN module 25). The firmware-based operations have options that can be selected whether to execute them or not, and the device intermittently enables the communication function (e.g., attempts LCM HTTP Boot), and when the communication function (e.g., BIOS Network) is enabled, it executes optional processing according to a command received from the external apparatus (e.g., server 2).

With this configuration, the communication function is enabled intermittently to acquire a command issued at the external apparatus, and the firmware option is processed according to the acquired command. Thus, even if an option that is used relatively infrequently is notified by a command obtained from the external apparatus, an opportunity to process the option is provided. This in turn facilitates firmware maintenance through the optional processing.

The electronic apparatus 1 may also include a timer (e.g., RTC timer) that measures the current time, and enable the communication function when the current time passes a predetermined date and time (e.g., MBM time).

With this configuration, the communication function is enabled at the predetermined date and time, and optional processing is executed in accordance with a command obtained from the external apparatus. This enables the communication function periodically, and thus offers an opportunity of executing a notified optional process periodically.

The above device may also be a host device that makes up the host system 10. The host system 10 may check the validity of the communication function during the initialization process.

This configuration allows the ability to receive a command from the external apparatus to be checked during the initialization process. This makes the optional process executed more reliably.

The host system 10 may start initialization processing when the current time passes a predetermined date and time and in a power-off state, and then change to the power-off state after completing optional processing.

With this configuration, after the optional processing is completed, the mode returns to the same power-off state as before the execution of the processing. Thus, the process is executed when not in use, without making the user aware of it.

The host system 10 may operate in a low-power mode, which is a power mode that consumes less power than the standard power mode, and when the current time passes a predetermined date and time, it may suspend the operation (e.g., transition to S4 state) before starting initialization processing, and after optional processing is completed, it may perform a restart processing (e.g., reboot) and change the power mode to the low-power mode.

With this configuration, the host system 10 pauses the operation before starting the initialization process when operating in the low power mode, which saves the execution state before the initialization process starts. After completion of the optional process, the host system returns to the same low-power mode state as before execution of the optional process. Thus, the process is executed when not in use, without making the user aware of it, and the system resumes from the execution state before execution of the optional process.

When the host system 10 detects a startup instruction in a power-off state, it may start initialization processing, enable the communication function when the current time passes a predetermined date and time, and execute startup processing after optional processing is completed.

With this configuration, when startup is instructed, after the current time reaches the predetermined date and time, the host system 10 executes optional processing and then the startup processing. This allows the host system to achieve the purpose of entering the startup state in response to the startup instruction, and execute optional processing intermittently before entering the startup state.

The device may repeat the process based on one of the unexecuted commands and a restart process after the process is completed until there are no unexecuted commands.

With this configuration, when a plurality of commands are notified from an external apparatus, the restart process is executed after execution of each of the commands. Therefore, even if the firmware configuration changes as a result of the execution of each of the commands, the state after the change is reflected in the functions of the host system 10 through the OS restart process.

Although the embodiments of the present application have been described in detail with reference to the drawings, the specific configuration of the present application is not limited to the above-described embodiments, and also includes design modifications or the like within the scope of the present invention. The configurations described in the above embodiments can be combined freely.

### DESCRIPTION OF SYMBOLS

S1 maintenance system
1 electronic apparatus
2 server
10 host system
11 CPU
12 main memory
13 video subsystem
14 display
21 chipset
22 ROM
23 storage
25 WLAN module
26 input/output I/F
31 EC
32 input device
34 power circuit
38 power button
110 BIOS processing unit
120 OS processing unit

What is claimed is:

1. An electronic apparatus comprising:
a device configured to perform an operation in accordance with firmware; and
an interface configured to provide a communication function, wherein
the operation has an option of being able to select whether or not to perform the operation,
the device is further configured to:
enable the communication function intermittently; and
when the communication function is enabled, execute processing of the option in accordance with a command received from an external apparatus.

2. The electronic apparatus according to claim 1, further comprising a timer to measure current time, wherein
when the current time passes a predetermined date and time, the device enables the communication function.

3. The electronic apparatus according to claim 2, wherein the device includes a host device included in a host system, and
the host system is configured to, in an initialization process, check validity of the communication function.

4. The electronic apparatus according to claim 3, wherein the host system is configured to,
when the current time passes a predetermined date and time while the electronic apparatus is in a power-off state, start the initialization process, and
after the process of the option is completed, return to the power-off state.

5. The electronic apparatus according to claim 3, wherein the host system is configured to operate in a low power mode that consumes less power than a standard power mode, wherein
when the current time passes a predetermined date and time, the host system suspends operation before starting the initialization process, and
after the process of the option is completed, the host system executes a restart process and change the power mode to the low power mode.

6. The electronic apparatus according to claim 3, wherein the host system is configured to
when detecting a startup instruction while the electronic apparatus is in a power-off state, start the initialization process,
when the current time passes a predetermined date and time, enable the communication function, and
after the process of the option is completed, execute a startup process.

7. The electronic apparatus according to claim 1, wherein the device is configured to
repeat a process in accordance with the command that is a single command unexecuted, and a restart process after completion of the process until there is no more the command that is unexecuted.

8. A control method for an electronic apparatus including: a device configured to perform an operation in accordance with firmware; and an interface configured to provide a communication function, the operation having an option of being able to select whether or not to perform the operation, the control method comprising:
enabling, at the device, the communication function intermittently; and
when the communication function is enabled, executing, at the device, processing of the option in accordance with a command received from an external apparatus.
